(19) United States
(12) Patent Application Publication
(10) Pub. No.: US 2025/0054156 A1
(43) Pub. Date: Feb. 13, 2025

(54) SEGMENTATION OF DIGITAL IMAGES USING A BINARY MASK

(71) Applicant: INTERNATIONAL BUSINESS MACHINES CORPORATION, ARMONK, NY (US)

(72) Inventors: Sharon Ladron de Guevara Contreras, IRVINE, CA (US); Augusto Vega, Poway, CA (US); Aporva Amarnath, White Plains, NY (US); Pradip Bose, Yorktown Heights, NY (US)

(21) Appl. No.: 18/230,830

(22) Filed: Aug. 7, 2023

(51) Int. Cl. G06T 7/11; G01S 17/89; G06T 7/50; G06T 7/62; G06V 10/25; G06V 10/764

(52) U.S. Cl. CPC G06T 7/11; G01S 17/89; G06T 7/50; G06T 7/62; G06V 10/25; G06V 10/764

(57) ABSTRACT

A method, computer program product, and computer system for segmenting camera images obtained by a digital camera and analyzing the segments by a machine learning model (MLM). A first and second digital image of a scene obtained by a digital camera and a depth sensor, respectively, are received. The first and second digital images are characterized by a first and second pixel configuration, respectively. Using the second digital image, a binary mask characterized by the second pixel configuration is generated, including selectively digitizing each pixel of the binary mask to 1 or 0 to identify one or more regions of the scene to be subsequently segmented from the first digital image. By applying the binary mask to the first digital image, segments of the first digital image are generated. Each generated segment corresponds to a subset of the pixels of the binary mask that are digitized to 1.

This invention was made with government support under Government Contract Number-HR0011-18-C-0122 awarded by Defense Advanced Research Projects Agency (DARPA). The government has certain rights to this invention.

### BACKGROUND

The present invention relates to segmenting digital images, and more specifically, to segmenting digital images obtained by a digital camera through use of a binary mask generated from a digital image obtained from a depth sensor.

### SUMMARY

Embodiments of the present invention provide a method, a computer program product, and a computer system, for segmenting camera images obtained by a digital camera and analyzing the segments by a machine learning model (MLM).

One or more processors of a computer system receive a first digital image of a scene obtained by a digital camera. The first digital image is characterized by a first pixel configuration.

The one or more processors receive a second digital image of the scene obtained by a depth sensor. The second digital image is characterized by a second pixel configuration.

The first and second digital images are obtained quasi-simultaneously.

Using the second digital image, the one or more processors generate a binary mask characterized by the second pixel configuration. Generating the binary mask includes selectively digitizing each pixel of the binary mask to 1 or 0 to identify one or more regions of the scene to be subsequently segmented from the first digital image.

By applying the binary mask to the first digital image, the one or more processors generate one or more segments of the first digital image. Each generated segment corresponds to a subset of the pixels of the binary mask that are digitized to 1.

### BRIEF DESCRIPTION OF THE DRAWINGS

FIG. 1A depicts object detection using a machine learning model (MLM) of YOLO®, in accordance with the prior art.

FIG. 1B depicts object detection using the machine learning model (MLM) of YOLO®, in accordance with embodiments of the present invention.

FIG. 2 is flow diagram describing an object detection method, in accordance with embodiments of the present invention.

FIG. 3 is a flow chart of a method for segmenting digital images obtained by a digital camera and analyzing the segments by a machine learning model (MLM), in accordance with embodiments of the present invention.

FIG. 4 is a flow chart of a process of generating a binary mask, in accordance with embodiments of the present invention.

FIG. 5 is a diagram depicting coordinates that may be used for determining designated regions in the scene, in accordance with embodiments of the present invention.

FIG. 6 is a flow chart of implementing a step of generating segments of a first digital image of the scene obtained by a digital camera, in accordance with embodiments of the present invention.

FIG. 7 illustrates a computer system, in accordance with embodiments of the present invention.

FIG. 8 depicts a computing environment which contains an example of an environment for the execution of at least some of the computer code involved in performing the inventive methods, in accordance with embodiments of the present invention.

### DETAILED DESCRIPTION

Typically, in real-time Object Detection and Classification (OD & C) algorithms, there is a positive correlation between the complexity of the model and the accuracy, which shows, for example, on different versions of the You Only Look Once (YOLO®) algorithm for object detection. The YOLO®, algorithm uses neural networks to provide real-time object detection and is has been used in various applications to detect traffic signals, people, parking meters, animals, etc.

Today's Artificial Intelligence (AI) algorithms for object detection are based on deep-learning models. Deep-learning-based models are complex and require a high number of parameters and high-resolution data, which results in reduced hardware performance. For instance, the more resolution in the AI, the less frames per seconds can be processed.

Increments in memory usage due to the resolution of the input data, as well as the model's size, are unsustainable for constrained devices. A constrained device is a computing device that has limited resources such as processing power, memory, energy, and/or storage capacity. Constrained devices are typically designed to perform specific functions while operating within tight constraints on resources.

Embodiments of the present invention perform preprocessing with multiple sensors to reduce input data and lower parameters of the machine learning models, which reduces computation and memory requirements of the OD &C execution. The multiple sensors include a digital camera and a depth sensor to enable the use of lightweight OD &C models and therefore relax the memory demand while sustaining comparable accuracy level. The depth sensor may be, inter alia, Light Detection and Ranging (LiDAR) or Radio Detection and Ranging (RADAR).

A LIDAR device includes a transmitter and a receiver. The transmitter uses laser pulses light (typically infrared light), which reflects from objects and returns to the receiver. The time it takes the laser pulse light to return to the LiDAR device is the measure of the distance between the LiDAR device and the object. The laser pulse light of the LiDAR device undergoes a periodic scanning motion (e.g., a sweeping motion or rotational motion) and is thus characterized by a scanning period or scanning frequency. The LiDAR device may have a 360° viewing angle (e.g., by using a rotating mirror), enabling the LiDAR device to sample a point cloud of the environment or scene. Specialized software can then generate a three-dimensional (3D) image that identifies positions in space (including spatial coordinates) for each spatial position in the point cloud.

A RADAR device operates similarly to a LiDAR device, with a major difference being that the RADAR device uses radio waves instead of laser pulses of infrared light. The RADAR device transmits radio waves from a rotating or fixed antenna and measures a time of flight of the reflected signal. As with LiDAR, the RADAR device can have a scanning period which refers to the time it takes for the radar to complete one full scan of its surroundings. With its radio wave wavelength, the RADAR device can detect objects at long distances and through fog or clouds, but its lateral resolution is limited by the size of the antenna. A resolution of standard RADAR is several meters at a distance of 100 meters. In contrast, a Lidar device can have a resolution of a few centimeters at a distance of 100 meters.

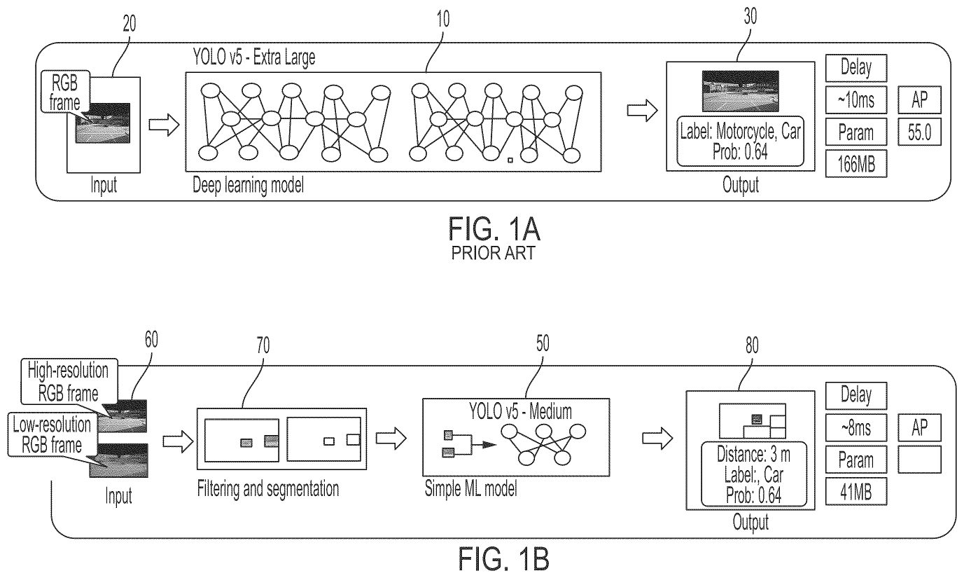

FIG. 1A depicts object detection using a machine learning model (MLM) of YOLO® 10, in accordance with the prior art.

In FIG. 1A, a camera obtains a digital image of a scene. The digital image in FIG. 1A, which is in a RBG frame 20, is provided as input to the MLM 10 which classifies an object in the scene, and the classification of the object appears in output 30.

FIG. 1B depicts object detection using the machine learning model (MLM) of YOLO®, 50, in accordance with embodiments of the present invention.

In FIG. 1B, a camera obtains a digital image of a scene which is the same scene, or essentially the same scene, as the scene in FIG. 1A. Moreover, the digital image in FIG. 1B is the same digital image, or essentially the same digital image, as the digital image in FIG. 1A. The digital image in FIG. 1B, which is in a RBG frame 60, is provided as input to the MLM 50 after the digital image has been simplified by filtering and segmentation 70. The MLM 50 classifies the object in the scene, and the classification of the object appears in output 80.

As seen in FIGS. 1A and 1B, the MLM 50 in FIG. 1B has much fewer nodes than the MLM 10 in FIG. 1A, because portions of the scene not needed for performing the classification are removed from the digital image by filtering and segmentation 70 via use of a binary mask, resulting in a 20% reduction in execution delay time (i.e., ˜8 ms versus ˜10 ms) and in a much lower MLM parameter storage of 41 MB versus 166 MB as depicted in output 80 of FIG. 1B and in output 30 of FIG. 1A, respectively.

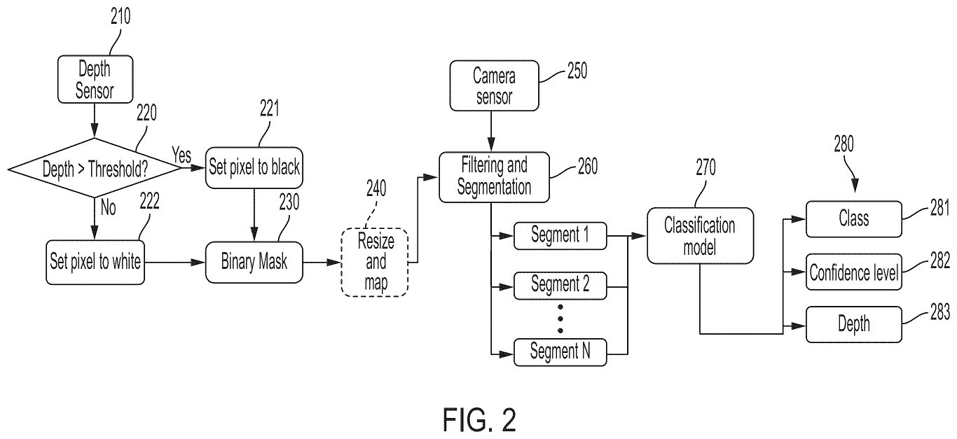

FIG. 2 is flow diagram describing an object detection method, in accordance with embodiments of the present invention.

A depth sensor 210 and a digital camera 250 obtain respective digital images of a scene. The depth sensor may be, inter alia, a LiDAR device or a RADAR device.

The digital image obtained by the digital camera 250 is denoted as a first digital image, and the digital image obtained by the depth sensor 210 is denoted as a second digital image. In one embodiment, the first digital image and the second digital image are each in a RGB frame.

The first digital image obtained by the digital camera 250 and the second digital image obtained by the depth sensor 210 are respective digital images of a same scene.

The first digital image obtained by the digital camera 250 and the second digital image obtained by the depth sensor 210 are obtained quasi-simultaneously.

“Quasi-simultaneously” has the following definition: obtaining the respective digital images quasi-simultaneously means that the respective digital images are obtained simultaneously, or are obtained by the digital camera 250 and the depth sensor 210 at times t1 and t2, respectively, such that the scene is unchanged, or essentially unchanged between times t1 and t2, wherein t1<t2.

“Essentially unchanged” has the following definition: the scene is essentially unchanged if the spatial resolution of the digital images obtained by the camera 250 and the depth sensor 210 is insensitive to any change in the scene that occurred between times t1 and t2.

In one embodiment, the scene is dynamic and changes continuously (e.g., a scene of traffic of vehicles on a highway or street).

In one embodiment, the scene is static and does not change over large time periods (e.g., a natural scene of a mountain or a farm field of crops).

The digital camera 250 and the depth sensor 210 may be spatially separated when obtaining the respective digital images of the scene.

In one embodiment, the digital camera 250 and the depth sensor 210 are quasi-coincident when obtaining the respective digital images. “Quasi-coincident” has the following definition: the digital camera 250 and the depth sensor 210 are sufficiently close spatially to avoid orientation related anomalies (i.e., the digital images obtain from the depth sensor 210 and the camera 250 are insensitive to an angular deviation resulting from the distance separation between the digital camera 250 and the depth sensor 210).

In one embodiment, the digital camera 250 and the depth sensor 210 are not quasi-coincident when obtaining the respective digital images. Being “not quasi-coincident” is defined as follows: a spatial separation the digital camera 250 and the depth sensor 210 results in differences in the respective digital images obtained by the digital camera 250 and the depth sensor 210, respectively, due to an angular difference between the respective lines of sight of the digital camera 250 and the depth sensor 210 with respect to the scene. For this embodiment, at least one digital image of the respective digital images could be transformed in a manner that accounts for the angular difference.

The digital image obtained by the digital camera 250 and the depth sensor 210 is characterized by a first pixel configuration and a second pixel configuration, respectively. A pixel configuration is defined by a spatial size of each pixel in the pixel configuration.

In one embodiment, the first pixel configuration and the second pixel configuration are a same pixel configuration.

In one embodiment, the first pixel configuration and the second pixel configuration are different pixel configurations.

Each pixel of the respective digital images obtained by the digital camera 250 and the depth sensor 210 corresponds to a location (i.e., a spatial coordinate) in the scene.

For a two-dimensional scene, the pixel configuration is two-dimensional and each pixel is a rectangle. For a two-dimensional scene, there is no depth dimension normal to a plane that includes the scene.

For a three-dimensional scene, the pixel configuration is three-dimensional and each pixel is a cube. In contrast with a two-dimensional scene, the three dimensions of a three-dimensional scene includes the depth dimension.

Steps 220-222 generate a binary mask 230, wherein each pixel having a binary value of 0 (corresponding to black) will be filtered (i.e., suppressed) by the binary mask 230, and each pixel having a binary value of 1 (corresponding to white) will be transmitted by the binary mask 230.

For each pixel of the first digital image obtained by the depth sensor 210, step 220 determines whether the location in the scene to which the pixel corresponds is separated from a reference location (i.e., reference coordinate) in the scene by a separation depth that exceeds a specified threshold depth. If so, then the pixel is set to a binary value of 0 (black). If not, then the pixel is set to a binary value of 1 (white).

The reference location in the scene is the location in the scene which is closest to the depth sensor 210.

In the embodiment of FIG. 2, the scene is three dimensional and the separation depth is in a depth dimension of the scene. For the condition of separation depth>threshold depth (Yes branch from step 220), all locations in the scene, in the depth dimension, which are behind a location corresponding to the specified threshold distance are filtered (i.e., suppressed) by the binary mask 230.

The binary mask 230 is characterized by the second pixel configuration of the second digital image obtained by the depth sensor 210.

Step 240 is performed for an embodiment in which first pixel configuration and the second pixel configuration are different pixel configurations, wherein the second pixel configuration is either coarser or finer than the first pixel configuration. Accordingly, step 240 transforms the second pixel configuration of the binary mask 230 to the first pixel configuration, resulting in the binary mask being characterized by the first pixel configuration.

If the second pixel configuration is coarser than the first pixel configuration, it is assumed that each pixel of the second pixel configuration coincides with a respective plurality of pixels in the first pixel configuration, and step 240 replaces each pixel in the binary mask 230 with the respective plurality of pixels in the first digital configuration and sets the binary value of each pixel of the plurality of pixels in the binary mask 230 to the binary value of the pixel of the second pixel configuration.

For example, if a given pixel of the second pixel configuration has a binary value of B, where B is 0 or 1, and if the respective plurality of pixels in the first pixel configuration is 4 pixels, then the 4 pixels replace the given pixel in the binary mask 230 and the binary value of each of the 4 pixels in the binary mask 230 are set to B.

If the second pixel configuration is finer than the first pixel configuration, it is assumed that each replacement pixel of the first pixel configuration coincides with a plurality of pixels of the second pixel configuration, and step 240 sets the binary value of the replacement pixel in the binary mask 230 to an arithmetic average of values of the pixels in the plurality of pixels, rounded to 0 or 1 if the arithmetic average differs from 0.5. If the arithmetic average is equal to 0.5, then step 240 randomly selects, from a uniform probability distribution, 0 or 1 for the binary value of the pixel of the replacement pixel in the binary mask 230.

For example, if the plurality of pixels is 4 pixels in the second pixel configuration that corresponds to a replacement pixel in the first pixel configuration, and if the 4 pixels have binary values of 0, 1, 1, and 1, then the arithmetic average of 0.75 rounds to 1 which becomes the binary value of the replacement pixel in the binary mask 230.

Step 260 filters the first digital image obtained by the digital camera 250, using the binary mask 230, to generate one or more segments of the scene in the first digital image, wherein each segment corresponds to a designated region of the scene. The one or more segments are denoted as N segments in FIG. 2, namely Segment 1, Segment 2, . . . , Segment N, and wherein N is a positive integer of at least 1.

The N segments are input to a trained classification model 270 which is a trained MLM. The classification model 270 classifies an object in each segment and generates output 280.

For one segment of the N segments, the output 280 includes a classification 281 of an object in the one segment, a confidence level 282 of the classification 281, and a depth 283 of the object in the one segment from the reference location in the scene.

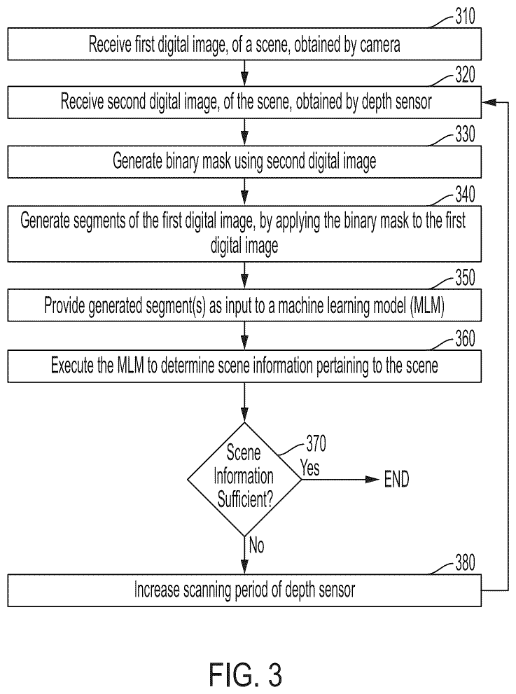

FIG. 3 is a flow chart describing a method of segmenting digital images obtained by a digital camera and analyzing the segments by a machine learning model (MLM), in accordance with embodiments of the present invention. The method of FIG. 3 includes steps 310-380.

Step 310 receives a first digital image of a scene obtained by a digital camera. The first digital image is characterized by a first pixel configuration. In one embodiment, the first digital image is in a RGB frame.

Step 320 receives a second digital image of the scene obtained by a depth sensor. The second digital image is characterized by a second pixel configuration. In one embodiment, the second digital image is in a RGB frame. The depth sensor may be, inter alia, Light Detection and Ranging (LiDAR) or Radio Detection and Ranging (RADAR).

A pixel configuration is defined by a spatial size of each pixel in the pixel configuration.

In one embodiment, the first pixel configuration and the second pixel configuration are a same pixel configuration.

In one embodiment, the first pixel configuration and the second pixel configuration are different pixel configurations.

Each pixel of the first digital image obtained by the digital camera and the second digital image obtained by the depth sensor corresponds to a location (i.e., a spatial coordinate) in the scene.

For a two-dimensional scene, the pixel configuration is two-dimensional and each pixel is a rectangle. For a two-dimensional scene, there is no depth dimension normal to a plane that includes the scene.

For a three-dimensional scene, the pixel configuration is three-dimensional and each pixel is a cube. In contrast with a two-dimensional scene, the three dimensions of a three-dimensional scene includes the depth dimension.

The first digital image obtained by the depth sensor and the second digital image obtained by the camera are obtained quasi-simultaneously. “Quasi-simultaneously” has been defined supra in the description of FIG. 2.

In one embodiment, the scene is dynamic and changes continuously (e.g., a scene of traffic of vehicles on a highway or street).

In one embodiment, the scene is static and does not change over large time periods (e.g., a natural scene of a mountain or a farm field of crops).

The digital camera and the depth sensor may be spatially separated when obtaining the respective digital images of the scene.

In one embodiment, the digital camera and the depth sensor are quasi-coincident when obtaining the respective digital images. “Quasi-coincident” has been defined supra in the description of FIG. 2.

In one embodiment, the digital camera and the depth sensor are not quasi-coincident when obtaining the respective digital images. Being “not quasi-coincident” has been defined supra in the description of FIG. 2.

If the digital camera and the depth sensor are not quasi-coincident, then at least one digital image of the respective digital images could be transformed in a manner that accounts for the angular difference between the respective lines of sight of the digital camera and the depth sensor with respect to the scene.

Step 330 generates, using the second digital image, a binary mask characterized by the second pixel configuration obtained by the depth sensor. Generating the binary mask comprises selectively digitizing each pixel of the binary mask to 1 or 0 to identify one or more regions of the scene to be subsequently segmented from the first digital image.

Step 340 generates, by applying the binary mask to the first digital image obtained by the digital camera, one or more segments of the first digital image. Each generated segment corresponds to a subset of the pixels of the binary mask that are digitized to 1. Each pixel having a binary value of 0 (corresponding to black) will be filtered (i.e., suppressed) by the binary mask, and each pixel having a binary value of 1 (corresponding to white) will be transmitted by the binary mask.

Step 350 provides at least one segment of the one or more segments generated in step 340 as input to a machine learning model (MLM).

Step 360 executes the MLM to determine scene information pertaining to the scene.

In one embodiment, the scene information determined from executing the MLM is a classification of an object in each segment of the at least one segment.

In one embodiment, the at least one segment provided as input to the MLM in step 350 is a plurality of segments, and the scene information determined from executing the MLM is a geometric relationship between a first segment and a second, different segment of the plurality of segments. The geometric relationship is between respective entities in the first and second segments, wherein each entity of the respective entities is independently selected from the group consisting of a spatial location, a line, an area, and a boundary of an area, a volume, or an object.

In one embodiment, step 370 determines whether the scene information is sufficiently spatially refined and if so the method ends, and if not step 380 increases a scanning period of the depth sensor followed by iteratively repeating steps 320-370 until the scene information is sufficiently spatially refined.

Increasing the scanning period of the depth sensor slows the scanning of the depth sensor which enables the depth sensor to obtain more spatially refined information about the scene.

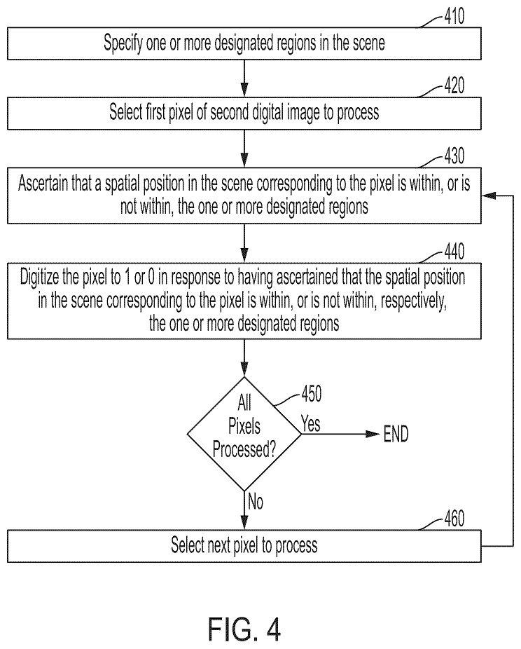

FIG. 4 is a flow chart of a process for generating a binary mask, in accordance with embodiments of the present invention. The process of FIG. 4 is an embodiment of implementing step 330 in FIG. 3 and includes steps 410-460.

Step 410 specifies one or more designated regions in the scene.

Step 420 selects a first pixel of the second digital image to process.

Step 430 ascertains that a spatial position in the scene corresponding to the pixel is within, or is not within, the one or more designated regions in the scene.

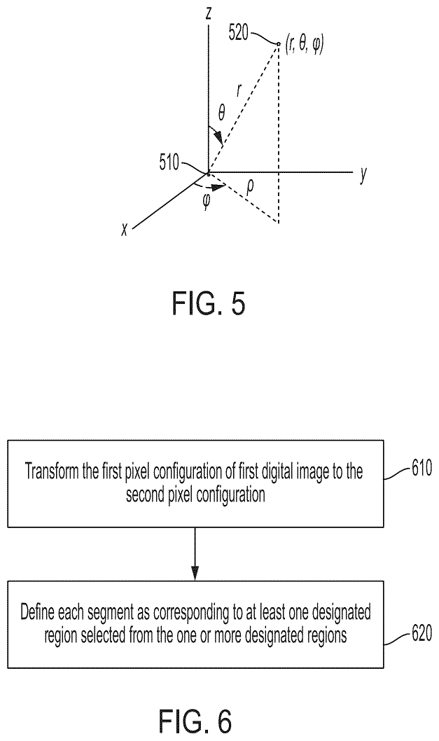

FIG. 5 is a diagram depicting coordinates that may be used for determining designated regions in the scene, in accordance with embodiments of the present invention. FIG. 5 shows a spatial position 520 with respect to reference location 510 in the scene. The reference location 510 in the scene is the location in the scene which is closest to the depth sensor.

A list of the coordinates depicted in FIG. 5 include rectangular coordinates x and y, elevation (z), depth (r), projected depth (ρ), polar angle (θ), and azimuthal angle (φ).

The elevation (z) and projected depth (ρ) are related to depth (r) and polar angle (θ) via: z=r cos (θ) and ρ=r sin (θ).

The rectangular coordinate (x) and rectangular coordinate (y) are related to the projected depth (ρ) and azimuth angle (φ) via: x=ρ cos (φ) and y=ρ sin (φ).

Various combinations of three coordinates selected from the preceding list of coordinates may be used to uniquely determine the spatial position 520 with respect to reference location 510.

In a first embodiment, a combination of three coordinates that may be used to uniquely determine the spatial position 520 with respect to reference location 510 is: rectangular coordinate (x), rectangular coordinate (y), and elevation (z).

In a second embodiment, a combination of three coordinates that may be used to uniquely determine the spatial position 520 with respect to reference location 510 is: depth (r), polar angle (θ), and azimuthal angle (φ).

In a third embodiment, a combination of three coordinates that may be used to uniquely determine the spatial position 520 with respect to reference location 510 is: depth (r), elevation (z), and azimuthal angle (φ).

The following discussion pertaining to the designated regions is expressed in terms of the preceding third embodiment, using depth (r), elevation (z), and azimuthal angle (φ).

A designated region in the scene is a region for which the associated pixels in the mask have a binary value of 1. The designated region may be determined, in one embodiment, by a location constraint on the spatial position 520, wherein the spatial position 520 is within the designated region if the spatial position 520 satisfies the location constraint.

In one embodiment, the location constraint is a depth constraint (i.e., a constraint on the depth (r)) on the spatial position 520. For example, the depth constraint in step 220 of FIG. 2 is: depth>depth threshold.

Generally, the depth constraint is any constraint on the depth (r); for example: r>rₜₕ; r<rₜₕ; rₜₕ₁<r<rₜₕ₂; rₜₕ₁<<rₜₕ₂ and rₜₕ₃<<rₜₕ₄; etc., wherein rₜₕ, rₜₕ₁, rₜₕ₂, rₜₕ₃, and rₜₕ₄ are depth constraint thresholds.

In one embodiment, the location constraint is a depth constraint and an azimuthal angle constraint (i.e., a constraint on the azimuthal angle (θ)) on the spatial position 520.

In one embodiment, the location constraint is a depth constraint and an elevation constraint (i.e., a constraint on the elevation (z)) on the spatial position 520.

In one embodiment, the location constraint is a depth constraint, an azimuthal angle constraint, and an elevation constraint on the spatial position 520.

In summary, the location constraint is selected from the group consisting of: (i) a depth constraint on the spatial position 520, (ii) the depth constraint and an azimuthal angle constraint on the spatial position 520, (iii) the depth constraint and an elevation constraint on the spatial position 520, and (iv) the depth constraint, the azimuthal angle constraint, and the elevation constraint on the spatial position 520.

Accordingly, step 430 ascertains that a spatial position in the scene corresponding to the pixel is within, or is not within, the one or more designated regions in the scene, by determining whether the spatial position satisfies, or does not satisfy, the location constraint, respectively.

Returning to FIG. 4, step 440 digitizes the pixel to 1 or 0 in response to having ascertained in step 430 that the spatial position in the scene corresponding to the pixel is within, or is not within, respectively, the one or more designated regions.

Step 450 determines whether all pixels in the second digital image have been processed, and if so then the process of FIG. 4 ends, and if not the step 460 selects a next pixel of the second digital image to process, followed by iteratively repeating steps 430-460 until all pixels of the second digital image have been processed.

FIG. 6 is a flow chart of implementing a step of generating segments of the first digital image of the scene obtained by the digital camera, in accordance with embodiments of the present invention. The process of FIG. 6 is an embodiment of implementing step 340 in FIG. 3 and includes steps 610-620.

Step 610, which is performed if the second pixel configuration obtained by the depth sensor differs from the first pixel configuration obtained by the digital camera, transforms the second pixel configuration of the binary mask to the first pixel configuration, resulting in the binary mask being characterized by the first pixel configuration.

If step 610 is performed, the second pixel configuration obtained by the camera is either coarser or finer than the first pixel configuration obtained by the depth sensor.

If the second pixel configuration is coarser than the first pixel configuration, it is assumed that each pixel of the second pixel configuration coincides with a respective plurality of pixels in the first pixel configuration, and step 610 replaces each pixel in the binary mask with the respective plurality of pixels in the first digital configuration and sets the binary value of each pixel of the plurality of pixels in the binary mask to the binary value of the pixel of the second pixel configuration.

For example, if a given pixel of the second pixel configuration has a binary value of B, where B is 0 or 1, and if the respective plurality of pixels in the first pixel configuration is 4 pixels, then the 4 pixels replace the given pixel in the binary mask and the binary value of each of the 4 pixels in the binary mask are set to B.

If the second pixel configuration is finer than the first pixel configuration, it is assumed that each replacement pixel of the first pixel configuration coincides with a plurality of pixels of the second pixel configuration, and step 610 sets the binary value of the replacement pixel in the binary mask to an arithmetic average of values of the pixels in the plurality of pixels, rounded to 0 or 1 if the arithmetic average differs from 0.5. If the arithmetic average is equal to 0.5, then step 610 randomly selects, from a uniform probability distribution, 0 or 1 for the binary value of the pixel of the replacement pixel in the binary mask 230.

Step 620 defines each segment as corresponding to at least one designated region selected from the one or more designated regions, wherein the subset of the pixels of the binary mask digitized to 1 are the pixels digitized to 1 that correspond to the at least one designated region.

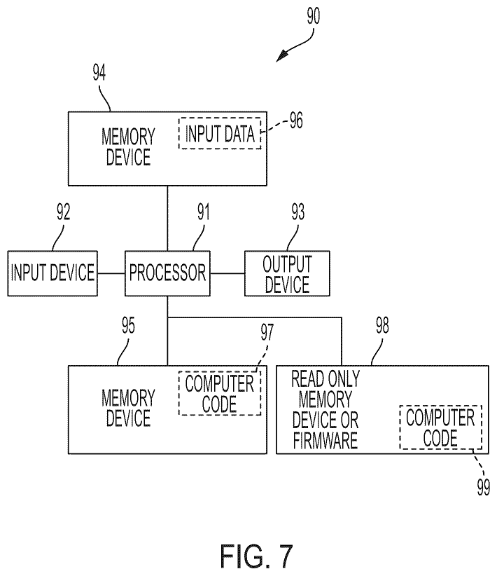

FIG. 7 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

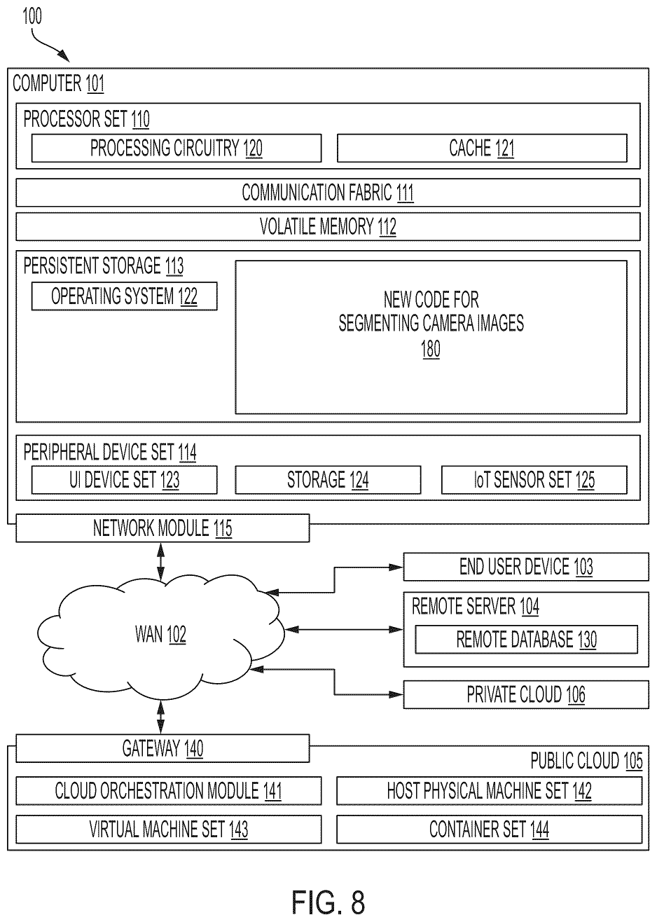

FIG. 8 depicts a computing environment 100 which contains an example of an environment for the execution of at least some of the computer code involved in performing the inventive methods, in accordance with embodiments of the present invention. Such computer code includes new code for segmenting camera images 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 8. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for segmenting digital images obtained by a digital camera and analyzing the segments by a machine learning model (MLM), said method comprising:
receiving, by one or more processors of a computer system, a first digital image of a scene obtained by a digital camera, said first digital image characterized by a first pixel configuration;
receiving, by the one or more processors, a second digital image of the scene obtained by a depth sensor, said second digital image characterized by a second pixel configuration; said first and second digital images being obtained quasi-simultaneously;
generating, by the one or more processors using the second digital image, a binary mask characterized by the second pixel configuration, wherein said generating the binary mask comprises selectively digitizing each pixel of the binary mask to 1 or 0 to identify one or more regions of the scene to be subsequently segmented from the first digital image; and
generating, by the one or more processors by applying the binary mask to the first digital image, one or more segments of the first digital image, each generated segment corresponding to a subset of the pixels of the binary mask that are digitized to 1.

2. The method of claim 1, wherein said generating the binary mask comprises for each pixel of the second pixel configuration:
specifying one or more designated regions in the scene;
ascertaining that a spatial position in the scene corresponding to the pixel is within, or is not within, the one or more designated regions; and
digitizing the pixel to 1 or 0 in response to having ascertained that the spatial position in the scene corresponding to the pixel is within, or is not within, respectively, the one or more designated regions.

3. The method of claim 2, wherein said ascertaining comprises ascertaining that the spatial position in the scene corresponding to the pixel is within or not within a location constraint defining each designated region of the one or more designated regions in the second digital image, and wherein the location constraint is selected from the group consisting of: (i) a depth constraint on the spatial position, (ii) the depth constraint and an azimuthal angle constraint on the spatial position, (iii) the depth constraint and an elevation constraint on the spatial position, and (iv) the depth constraint, the azimuthal angle constraint, and the elevation constraint on the spatial position.

4. The method of claim 2, wherein the second pixel configuration differs from the first pixel configuration, and wherein said generating the one or more segments of the first digital image comprises:
transforming the second pixel configuration of the binary mask to the first pixel configuration, resulting in the binary mask being characterized by the first pixel configuration.

5. The method of claim 2, wherein said generating the one or more segments of the first digital image comprises:
defining each segment as corresponding to at least one designated region selected from the one or more designated regions, wherein the subset of the pixels of the binary mask digitized to 1 are the pixels digitized to 1 that correspond to the at least one designated region.

6. The method of claim 1, wherein the method further comprises:
providing, by the one or more processors, at least one segment of the one or more segments as input to the machine learning model (MLM); and
executing, by the one or more processors, the MLM to determine scene information pertaining to the scene.

7. The method of claim 6, wherein the scene information determined from said executing the MLM is a classification of an object in each segment of the at least one segment.

8. The method of claim 6, wherein the at least one segment is a plurality of segments, and wherein the scene information determined from said executing the MLM is a geometric relationship between a first segment and a second, different segment of the plurality of segments, wherein the geometric relationship is between respective entities in the first and second segments, and wherein each entity of the respective entities is independently selected from the group consisting of a spatial location, a line, an area, and a boundary of an area, a volume, or an object.

9. The method of claim 6, wherein the method further comprises:
determining, by the one or more processors, that the scene information that was determined from said executing the MLM is not sufficiently spatially refined and in response, increasing, by the one or more processors, a scanning period of the depth sensor and repeating said receiving the second digital image of the scene, said generating the binary mask, said generating the one or more segments of the first digital image, said providing the at least one segment as input to the MLM, and said executing the MLM.

10. The method of claim 1, wherein the depth sensor is Light Detection and Ranging (LiDAR).

11. The method of claim 1, wherein the depth sensor is Radio Detection and Ranging (Radar).

12. A computer program product, comprising one or more computer readable hardware storage devices having computer readable program code stored therein, said program code containing instructions executable by one or more processors of a computer system to implement a method for segmenting digital images obtained by a digital camera and analyzing the segments by a machine learning model (MLM), said method comprising:
receiving, by the one or more processors, a first digital image of a scene obtained by a digital camera, said first digital image characterized by a first pixel configuration;
receiving, by the one or more processors, a second digital image of the scene obtained by a depth sensor, said second digital image characterized by a second pixel configuration; said first and second digital images being obtained quasi-simultaneously;
generating, by the one or more processors using the second digital image, a binary mask characterized by the second pixel configuration, wherein said generating the binary mask comprises selectively digitizing each pixel of the binary mask to 1 or 0 to identify one or more regions of the scene to be subsequently segmented from the first digital image; and
generating, by the one or more processors by applying the binary mask to the first digital image, one or more segments of the first digital image, each generated segment corresponding to a subset of the pixels of the binary mask that are digitized to 1.

13. The computer program product of claim 12, wherein said generating the binary mask comprises for each pixel of the second pixel configuration:
specifying one or more designated regions in the scene;
ascertaining that a spatial position in the scene corresponding to the pixel is within, or is not within, the one or more designated regions; and
digitizing the pixel to 1 or 0 in response to having ascertained that the spatial position in the scene corresponding to the pixel is within, or is not within, respectively, the one or more designated regions.

14. The computer program product of claim 13, wherein said ascertaining comprises ascertaining that the spatial position in the scene corresponding to the pixel is within or not within a location constraint defining each designated region of the one or more designated regions in the second digital image, and wherein the location constraint is selected from the group consisting of: (i) a depth constraint on the spatial position, (ii) the depth constraint and an azimuthal angle constraint on the spatial position, (iii) the depth constraint and an elevation constraint on the spatial position, and (iv) the depth constraint, the azimuthal angle constraint, and the elevation constraint on the spatial position.

15. The computer program product of claim 13, wherein said generating the one or more segments of the first digital image comprises:
defining each segment as corresponding to at least one designated region selected from the one or more designated regions, wherein the subset of the pixels of the binary mask digitized to 1 are the pixels digitized to 1 that correspond to the at least one designated region.

16. The computer program product of claim 12, wherein the method further comprises:
providing, by the one or more processors, at least one segment of the one or more segments as input to the machine learning model (MLM); and
executing, by the one or more processors, the MLM to determine scene information pertaining to the scene.

17. A computer system, comprising one or more processors, one or more memories, and one or more computer readable hardware storage devices, said one or more hardware storage devices containing program code executable by the one or more processors via the one or more memories to implement a method for segmenting digital images obtained by a digital camera and analyzing the segments by a machine learning model (MLM), said method comprising:
receiving, by the one or more processors, a first digital image of a scene obtained by a digital camera, said first digital image characterized by a first pixel configuration;
receiving, by the one or more processors, a second digital image of the scene obtained by a depth sensor, said second digital image characterized by a second pixel configuration; said first and second digital images being obtained quasi-simultaneously;
generating, by the one or more processors using the second digital image, a binary mask characterized by the second pixel configuration, wherein said generating the binary mask comprises selectively digitizing each pixel of the binary mask to 1 or 0 to identify one or more regions of the scene to be subsequently segmented from the first digital image; and
generating, by the one or more processors by applying the binary mask to the first digital image, one or more segments of the first digital image, each generated segment corresponding to a subset of the pixels of the binary mask that are digitized to 1.

18. The computer system of claim 17, wherein said generating the binary mask comprises for each pixel of the second pixel configuration:
specifying one or more designated regions in the scene;
ascertaining that a spatial position in the scene corresponding to the pixel is within, or is not within, the one or more designated regions; and
digitizing the pixel to 1 or 0 in response to having ascertained that the spatial position in the scene corresponding to the pixel is within, or is not within, respectively, the one or more designated regions.

19. The computer system of claim 18, wherein said generating the one or more segments of the first digital image comprises:
defining each segment as corresponding to at least one designated region selected from the one or more designated regions, wherein the subset of the pixels of the binary mask digitized to 1 are the pixels digitized to 1 that correspond to the at least one designated region.

20. The computer system of claim 17, wherein the method further comprises:
providing, by the one or more processors, at least one segment of the one or more segments as input to the machine learning model (MLM); and
executing, by the one or more processors, the MLM to determine scene information pertaining to the scene.
